(19) United States
(12) Patent Application Publication
(10) Pub. No.: US 2023/0213906 A1
(43) Pub. Date: Jul. 6, 2023

(54) METHOD AND SYSTEM FOR OPTIMIZING A MANUAL ASSEMBLY LINE LAYOUT

(71) Applicant: Industrial Technology Research Institute, Hsinchu (TW)

(72) Inventors: Po-Kai LIU, Hsinchu County (TW); Chang-Hao YAU, New Taipei City (TW); Yi-Yun TSAI, Kaohsiung City (TW); Chun-Lung LIN, Taipei City (TW); Ching-Chieh LIN, Taipei City (TW)

(21) Appl. No.: 17/566,536

(22) Filed: Dec. 30, 2021

(51) Int. Cl. G05B 19/042

(52) U.S. Cl. CPC G05B 19/042; G05B 2219/2629

(57) ABSTRACT

A method for optimizing a manual assembly layout, executed by a processing device, including: analyzing the assembly operation and the operating time corresponding to the assembly operation of each of the assemblers based on the operating information of one or more assemblers; generating a plurality of candidate solutions based on the assembly operations, the operating time, and a plurality of condition parameters; selecting at least one of the candidate solutions to be the optimal solution based on the workload balance information of each of the candidate solutions.

### BACKGROUND

### Technical Field

The present disclosure is related to assembly line layout techniques, and in particular it is related to a method and system for optimizing a manual assembly line layout.

### Description of the Related Art

The assembly line refers to a manufacturing process in which objects are passed through a series of stations at a constant speed, and corresponding assembly operations are performed at each stations according to particular demands. The spirit of the assembly line is about allowing a production unit (e.g., a person or an apparatus) to focus on a specific task, instead of the previous method in which an entire product was completed by a single production unit from upstream to downstream.

Assembly firms that take High-Mix-Low-Volume (HMLV) orders may frequently generate demand for new assembly line layouts due to the production line changing rapidly. A decent assembly line layout would make the assembly actions of each station as simple as possible, and balance the workload among all the stations, so as to boost yield and production capacity.

However, current techniques of laying out an assembly line require a manager to input information simulating the status of production. Since the manager's knowledge and experience may be limited, the simulating information input by the manager may not reflect the real status of production. For example, the manager may underestimate the complexity of the assembly operation at a specific station, causing the real operating time at the station to be far longer than the operating time at other stations. Thus, the production capacity is reduced.

Furthermore, assemblers are the most crucial factors regarding the assembly layout in the scenario of a manual assembly line. However, the manager may not get to know the particular status of each of the assemblers in a short time. For example, the assembler at a specific station may not be familiar with the working techniques, or may have other temporary physical or mental factors affecting productivity, but the manager may be able to adjust the assembly line layout according to these situations immediately.

Therefore, there is a need for a method and a system that is capable of immediately providing suggestions for optimizing assembly line layout according to the on-site status of the assembly line.

### SUMMARY

The present disclosure provides a method for optimizing a manual assembly line layout, executed by a processing device, including: analyzing the assembly operation of each of the assemblers, and also analyzing the operating time corresponding to the assembly operation, based on the operating information of the assemblers; generating a plurality of candidate solutions based on the assembly operations, the operating time, and a plurality of condition parameters, wherein each of the candidate solutions indicates an assembly line layout that assigns the assembly operations to a plurality of stations; selecting at least one of the candidate solutions to be the optimal solution based on the workload balance information of each of the candidate solutions.

In some embodiments, the condition parameters comprise an upper bound of the station number. The number of stations is not higher than the upper bound of the station number.

In some embodiments, the condition parameters further include a minimum duration of the operating time, a maximum duration of the operating time, an operation priority rule, and an operation merging rule. The assembly line layouts that assign the assembly operations to the stations and are indicated by the candidate solutions all follow the operation priority rule and the operation merging rule. The sum of the operating time corresponding to the assembly operations that are assigned to each of the stations is not lower than the minimum duration of the operating time and not higher than the maximum duration of the operating time.

In some embodiments, generating the candidate solutions based on the assembly operations, the operating time, and the condition parameters, includes: assigning the assembly operations to a plurality of groups according to the operation priority rule; for each of the groups, assigning the assembly operations in the group to one or more subgroups according to the operation merging rule; determining whether to add the local layout of the one or more subgroups into a local solution of the group according to the minimum duration of the operating time, the maximum duration of the operating time, and the upper bound of the station number; generating the candidate solutions by combining the local solutions of the groups.

In some embodiments, generating the candidate solutions based on the assembly operations, the operating time, and the condition parameters, further includes: for each of the subgroups, determining whether the subgroup is divisible according to the minimum duration of the operating time, the maximum duration of the operating time, and the station number upper bound; dividing the subgroup if the subgroup is divisible, and adding the local layout of the subgroups that have been divided into the local solution of the group.

In some embodiments, determining whether to add the local layout of the one or more subgroups into the local solution of the group according to the minimum duration of the operating time, the maximum duration of the operating time, and the station number upper bound, includes: determining to add the local layout of the one or more subgroups into the local solution of the group if the number of subgroups is not greater than the station number upper bound, and the sum of the operating time corresponding to the assembly operations in the subgroups is not lower than the minimum duration of the operating time and not higher than the maximum duration of the operating time.

In some embodiments, the method provided by the present disclosure further includes calculating the minimum duration of the operating time and the maximum duration of the operating time based on the width of the object working area, a width of hand motions, and a range of conveyer belt speeds.

In some embodiments, the method provided by the present disclosure further includes calculating the upper bound of the station number based on station capacity and number of dispatchable workers.

In some embodiments, the workload balance information comprises a maximum action types for single station and a maximum amount of operating time for single station.

In some embodiments, selecting at least one of the candidate solutions to be the optimal solution based on the workload balance information of each of the candidate solutions includes: sifting one or more candidate solutions having the least maximum action types for single station of all of the candidate solutions; if only one candidate solution has the least maximum action types for single station of all of the candidate solutions, determining one candidate solution to be the optimal solution; if multiple candidate solutions have the least amount of maximum action types for single station of all of the candidate solutions, selecting the candidate solution having the least number of maximum amount of operating time for single station of all the multiple candidate solutions to be the optimal solution.

In some embodiments, selecting the candidate solutions to be the optimal solution based on the workload balance information of each of the candidate solutions includes: calculating the evaluation score of each of the candidate solutions using an evaluation function, based on the maximum action types for single station and the maximum amount of operating time for single station of each of the candidate solutions; selecting the candidate solution having the highest evaluation score or the lowest evaluation score of all of the candidate solutions to be the optimal solution.

In some embodiments, the method provided by the present disclosure further includes calculating the conveyer belt speed corresponding to the optimal solution based on the maximum amount of operating time for single station of the optimal solution, the width of the object working area, and the width of hand motions.

In some embodiments, the method provided by the present disclosure further includes calculating the estimated production capacity corresponding to the optimal solution based on the maximum amount of operating time for single station of the optimal solution, the length of the assembly line, the working duration, and the conveyer belt speed.

In some embodiments, analyzing the assembly operation of each of the assemblers and the operating time corresponding to the assembly operation based on the operating information of the assemblers includes: analyzing an action, an object in-hand, and an operated object from the operating information of each of the assemblers; obtaining the assembly operation of the assembler based on the action, the object in-hand, and the operated object.

The present disclosure also provides a system for optimizing a manual assembly line layout. The system includes an information-collecting unit and a computing unit. The information-collecting unit is configured to collect operating information of one or more assemblers. The computing unit is connected to the information-collecting unit. The computing unit includes a processing device that is configured to receive the operating information of the assemblers collected by the information-collecting unit, and execute the described method for optimizing a manual assembly line layout.

The method and system for optimizing a manual assembly layout is capable of immediately providing suggestions for optimizing the assembly line layout according to the on-site status of the assembly line, so that the assembly actions at each station is simplified, the workload among each stations is balanced, and the yield and the production capacity could be increased.

### BRIEF DESCRIPTION OF THE DRAWINGS

The present disclosure can be more fully understood by reading the subsequent detailed description of the exemplary embodiments with references made to the accompanying drawings. Moreover, it should be appreciated that the order of the execution of each blocks could be changed, and/or some of the blocks could be changed, deleted, or combined.

FIG. 1 illustrates the schematic diagram of the system architecture of a system for optimizing a manual assembly line layout and the accompanied application scenario of the system, according to an embodiment of the present disclosure.

FIG. 2 illustrates the flow diagram of a method for optimizing a manual assembly line layout, according to an embodiment of the present disclosure.

FIG. 3 illustrates the flow diagram of the detailed steps for analyzing the assembly operation of the assembler and the operating time corresponding to the assembly operation in some embodiments.

FIG. 4 illustrates the flow diagram of the detailed steps for generating candidate solutions in some embodiments.

FIG. 5 illustrates the schematic diagram of an example of assigning assembly operations to multiple groups.

FIG. 6A-6C shows an exemplary local layout that is added into the local solution of the group.

FIG. 7A and FIG. 7B shows an exemplary local layout that is added into the local solution of the group.

FIG. 8A-8F shows an exemplary assembly line layout generated in some embodiments.

FIG. 9 illustrates the flow diagram of the detailed steps for selecting the optimal solution in an embodiment.

FIG. 10 illustrates the flow diagram of the detailed steps for selecting the optimal solution in another embodiment.

### DETAILED DESCRIPTION

The following description is a preferred embodiment of the invention, which is intended to describe the basic spirit of the invention, but is not intended to limit the invention. The actual inventive content must be referenced to the scope of the following claims.

In each of the following embodiments, the same reference numbers represent identical or similar elements or components.

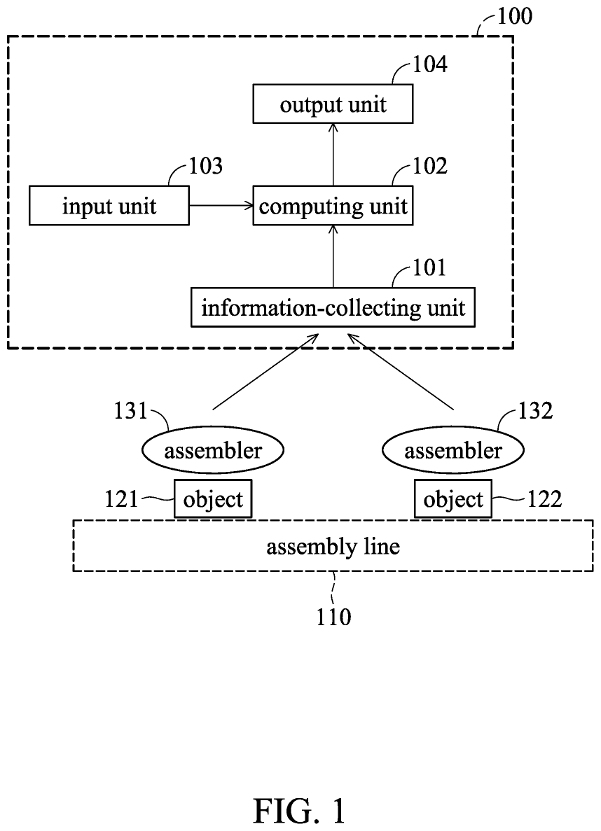

FIG. 1 illustrates the schematic diagram of the system architecture of a system 100 for optimizing a manual assembly line layout and the accompanied application scenario of the system, according to an embodiment of the present disclosure. As shown in FIG. 1, the system 100 may include an information-collecting unit 101, a computing unit 102, an input unit 103, and an output unit 104. The information-collecting unit 101 may be a sensing device or a camera device. The sensing device may include a variety of sensors, and an inertial measurement unit such as an accelerometer, a gyroscope, or a magnetometer, worn by an assembler (e.g., the assembler 131 and the assembler 132 in FIG. 1) to capture the actions of the assembler. The camera device may be any device used for photographing. The ways of photographing may include normal optical photographing or infrared photographing. The present disclosure is not limited to the types of the camera device or the ways of photographing. The camera device may be installed near the assembly line 110, and focus on the assemblers (e.g., the assembler 131 and the assembler 132 in FIG. 1) to capture images of assemblers. The computing unit 102 may be any apparatus including a processing device, such as a personal computer, a notebook computer, a server, or a smart phone. The processing device may be any device used for executing instructions, such as a central processing unit (CPU), a microprocessor, a controller, a microcontroller, or a state machine. The input unit 103 may be any apparatus that is able to receive data input from external, such as a keyboard, a mouse, a light pen, a touch panel, or a scanner. The output device 104 may be any apparatus that display the computing result in forms of texts, numbers, graphics, icons, or sounds, such as a monitor, a printer, or a speaker. The information-collecting unit 101, the computing unit 102, the input unit 103, and the output unit 104 may communicate with each other through a wired or wireless connection. Furthermore, the system 100 may further include a storage device (not shown in FIG. 1), such as random access memory (RAM), read only memory (ROM), EEPROM, flash memory or other memory devices, CD-ROM, DVD, or other optical storage device, and a hard disk, soft disk, magnetic disk, or other magnetic storage device, to store data required for calculating the optimal assembly line layout by the computing unit 102.

In the application scenario shown by FIG. 1, multiple stations (represented by two stations in the figure, not all of the stations are shown) may be deployed on the assembly line 110. There is a corresponding assembler (e.g., the assembler 131 and the assembler 132 in FIG. 1) responsible for assembling corresponding objects (e.g., the object 121 and the object 122 in FIG. 1) at each station. The information-collecting unit is used for collecting the operation information of each assembler (e.g., the assembler 131 and the assembler 132 in FIG. 1), such as image data or motion capture (MoCap) data, and transmitting the collected operating information to the computing unit 102. Input unit 103 is used for inputting the external parameters required for optimizing the assembly line layout, such as the allowable range of the operating time for single station, station capacity, priority rules of the assembly operations, rules for merging the assembly operations, . . . etc. The computing unit 102 is used for calculating the optimal assembly line layout (e.g., the number of stations deployed, and the operations responsible for the assembler at each station) and the corresponding information such as the estimated production capacity and conveyer belt speed, based on the operating information of each assembler collected by the information-collecting unit 101, and the external parameters input by the input unit 103. The output unit 104 is used for displaying the optimal assembly line layout calculated by the calculating unit 102, and corresponding information.

It should be appreciated that although only one information-collecting unit 101 is illustrated in FIG. 1, this does not mean that the present disclosure is limited to only using one device to collect operating information from multiple assemblers. In some embodiments, the information-collecting unit 101 may include multiple devices. In other embodiments, the information-collecting unit 101 may also be a combination of different types of devices (e.g., the camera devices and the sensing devices described previously). Although only one computing unit 102 is illustrated in FIG. 1, this does not mean that the present disclosure is limited to only using one device for calculating the optimal assembly line layout. In some embodiments, the computing unit 102 may be a distributed computing system in which multiple processing devices operate simultaneously, with each performing a part of the calculation. Although the information-collecting unit 101, the computing unit 102, the input unit 103, and the output unit 104 are illustrated together in FIG. 1, this does not mean that the locations of these units are limited by space. For example, in some cases, the information-collecting unit 101, the computing unit 102, and the input unit 103 may be located at the production end (or the near end) near the assembly line 110, while the output unit 104 may be located at the central control end (or the remote terminal) near the managers (not shown in the figure). In other cases, only the information-collecting unit 101 may be located at the production end (or the near end) near the assembly line 110, while the computing unit 102, the input unit 103, and the output unit 104 may be located at the central control end (or the remote terminal) near the managers (not shown in the figure).

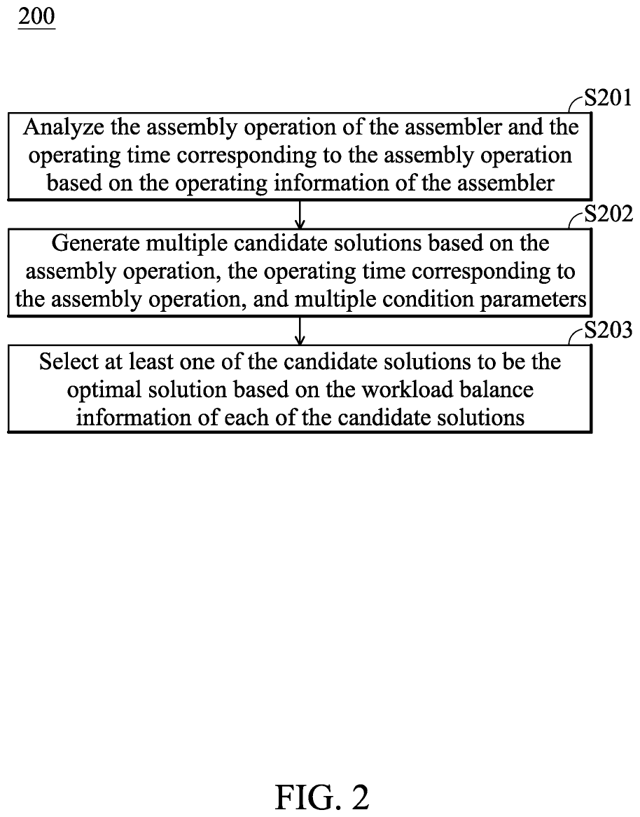

FIG. 2 illustrates the flow diagram of a method 200 for optimizing a manual assembly line layout, according to an embodiment of the present disclosure. As shown in FIG. 2, the method 200 includes steps S201-S203. Each step of the method 200 and its embodiments may be executed by the computing unit 102 in FIG. 1.

The method 200 starts in step S201. In step S201, the assembly operation of the assembler and the operating time corresponding to the assembly operation are analyzed based on the operating information of the assembler. Then, proceed to step S202.

At step S202, multiple candidate solutions are generated based on the assembly operation, the operating time corresponding to the assembly operation, and multiple condition parameters. Each of the candidate solutions indicates an assembly line layout that assigns the assembly operations to multiple stations, in other words the number of stations deployed on the whole assembly line, and the assembly operation that the assembler at each of the stations is responsible for. Then, proceed to step S203.

In step S203, at least one of the candidate solutions is selected to be the optimal solution based on the workload balance information of each of the candidate solutions. The optimal solution indicates the optimal layout that assigns the assembly operations to multiple stations. The optimal solution has the advantages of (i) assembly actions at each station is simplified and (ii) the workload among each stations is balanced. Adopting the optimal solution is expected to boost the yield and the production capacity.

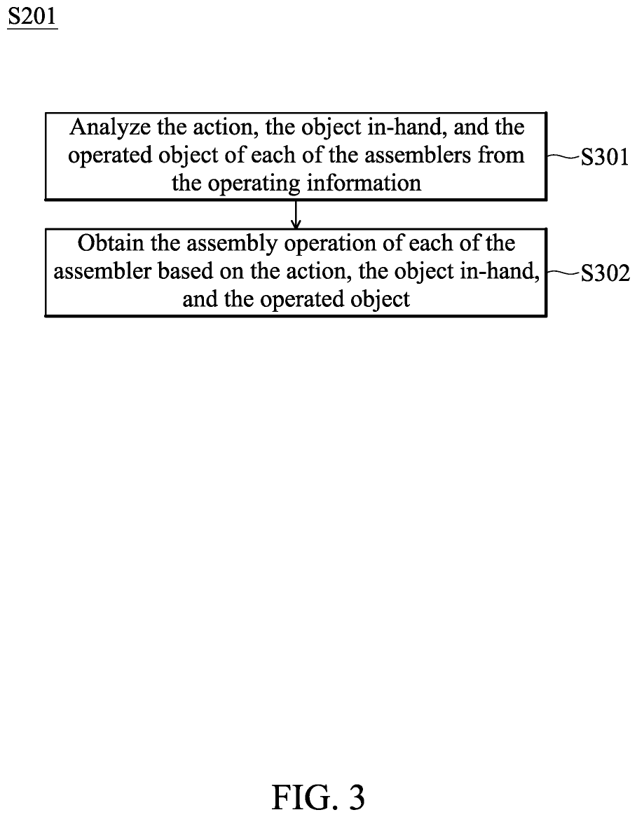

FIG. 3 illustrates the flow diagram of the detailed steps of step S201 in FIG. 2 in some embodiments. In these embodiments, as shown in FIG. 3, step S201 may be further divided into step S301 and step S302.

In step S301, the action, the object in-hand, and the operated object of each of the assemblers are analyzed from the operating information. For example, if the operation information is the image data collected by the camera device, the action, the object in-hand, and the operated object of each of the assemblers may be analyzed using any image processing technique (e.g., a variety of action recognition or object recognition techniques, the present disclosure is not limited thereto). If the operation information is the motion capture (MoCap) data collected by the sensing device, then the object in-hand and the operated object corresponding to the station where the assembler is located may be obtained by using RFID, NFC, or other indoor location-based service techniques. Then, proceed to step S302.

In step S302, the assembly operation of each of the assembler is obtained based on the action, the object in-hand, and the operated object of each of the assemblers. For example, if the analysis in step S301 shows that the action of the assembler is “locking the screw”, the object in-hand is “screwdriver”, and the operated object is “Board A”, then the assembly operation of the assembler may be inferred to be “fixing Board A with a screw”. Furthermore, the operating time required for the assembler to perform the assembly operation each time can be evaluated by accumulating the operation information for a long time. For example, we can obtain the mean value of the operating time of the assembly operation performed by the assembler for multiple times.

In some embodiments, the condition parameters may include an upper bound of the station number. The upper bound of the station number may be the predefined external parameter input by the manager using the input unit 103 in FIG. 1, or it may be generated by preprocessing based on other external parameters. In these embodiments, the candidate solutions generated in step S202 must satisfy the condition in which the number of stations deployed in the assembly line layout is not higher than the upper bound of the station number (e.g., 5 stations at most are allowed to be deployed).

In other embodiments, the condition parameters may further include an minimum duration of the operating time, a maximum duration of the operating time, an operation priority rule, and an operation merging rule. These condition parameters may the predefined external parameters input by the manager using the input unit 103 in FIG. 1, or they may be generated by preprocessing based on other external parameters. In these embodiments, the candidate solution generated in step S202 must satisfy the conditions as follows:

1. The assembly line layouts that assign assembly operations to the stations and that are indicated by the candidate solutions all follow the operation priority rule (e.g., some assembly operations must be performed before other assembly operations) and the operation merging rule (e.g., some assembly operations could be merged with some other assembly operations).
2. The sum of the operating time corresponding to the assembly operations that are assigned to each of the stations is not lower than the minimum duration of the operating time and not higher than the maximum duration of the operating time. This condition is to balance the workload among all the stations.

In some embodiments, the minimum duration of the operating time and the maximum duration of the operating time may be calculated based on external parameters such as the width of the object working area, the width of hand motions, and a range of conveyer belt speeds. The formulas are as follows:

$$lower bound of operating time = \frac{width of hand motions + width of object working area}{maximum conveyer belt speed}$$

$$upper bound of operating time = \frac{width of hand motions + width of object working area}{minimum conveyer belt speed}$$

In the formulas, the width of the object working area refers to the physical width of the object to be assembled, in other words the maximum width of the working area in which the assembly operation is performed. The width of hand motions refers to the maximum width the assembler's hands may reach.

In practical cases, the number of stations deployed on the assembly line may be limited by space resources and human resources. Therefore, in some embodiments, the upper bound of the station number may be calculated based on external parameters such as station capacity and number of dispatchable workers. The formula is as follows:

upper bound of station number=min(station capacity,number of dispatchable workers)

In the formula, the station capacity refers to the number of stations that can be accommodated in the limited volume of the assembly line. The number of dispatchable workers refers to the number of persons who can be assigned to be assemblers at the same time.

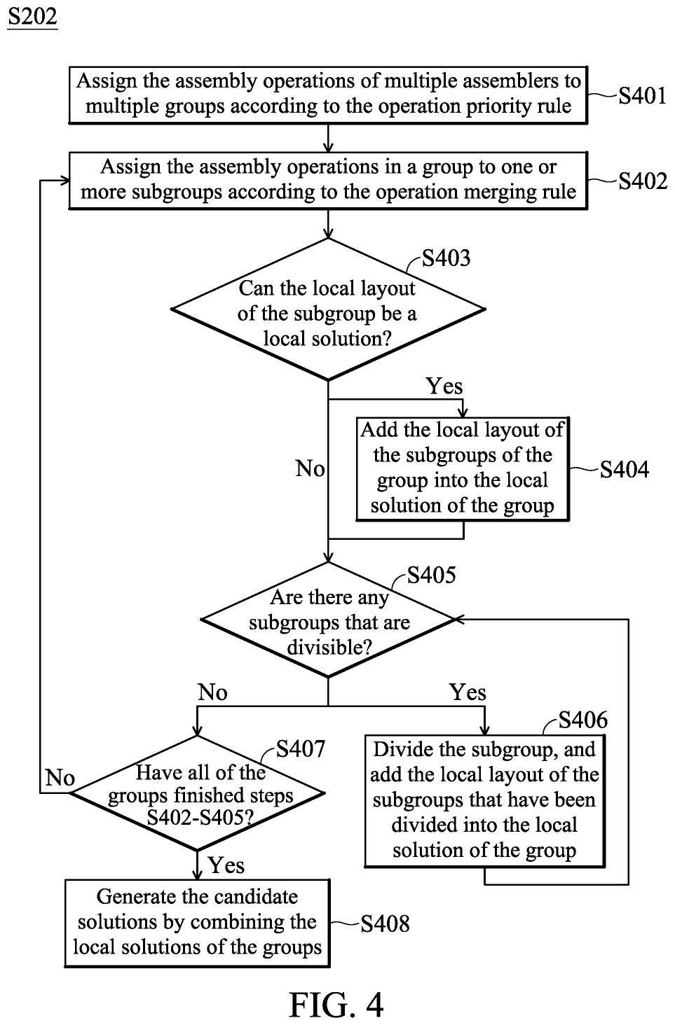

FIG. 4 illustrates the flow diagram of the detailed steps of step S202 in FIG. 2 in some embodiments. In these embodiments, as shown in FIG. 4, step S202 may be further divided into steps S401-S408.

In step S401, the assembly operations of multiple assemblers are assigned to multiple groups according to the operation priority rule. Then, proceed to step S402.

In step S402, the assembly operations in a group are assigned to one or more subgroups according to the operation merging rule. Then, proceed to step S403.

In step S403, whether the local layout of the subgroup can be a local solution is determined according to the condition parameters such as the minimum duration of the operating time, the maximum duration of the operating time, and the upper bound of the station number. Specifically, if the number of subgroups is not higher than the upper bound of the station number, and the sum of the operating time corresponding to the assembly operations in each of the subgroups is not lower than the minimum duration of the operating time and not higher than the maximum duration of the operating time, then it is determined that the local layout of the subgroups can be a local solution. If yes, proceed to step S404. If not, then skip step S404, and proceed directly to step S405.

In step S404, the local layout of the subgroups of the group is added into the local solution of the group. Then, proceed to step S405.

In step S405, whether there are any subgroups that are divisible is determined according to the minimum duration of the operating time, the maximum duration of the operating time, and the upper bound of the station number. Specifically, whether the layout of the subgroups that have been divided still satisfies the conditions in which the number of subgroups is not higher than the upper bound of the station number and the sum of the operating time corresponding to the assembly operations in each of the subgroups are all not lower than the minimum duration of the operating time and not higher than the maximum duration of the operating time, is considered. If yes, proceed to step S406. If not, proceed to step S407.

In step S406, the subgroup is divided, and the local layout of the subgroups that have been divided is added into the local solution of the group. Then, return to step S405, and continue to determine if there are subgroups that are divisible.

In step S407, whether all of the groups have finished steps S402-S405 is determined. If yes, proceed to step S408. If not, then return to step S402, to assign the assembly operations in the next group to one or more subgroups.

In step S408, the candidate solutions are generated by combining the local solutions of the groups, in other words, pairing the local layouts in the local solutions of each of the groups.

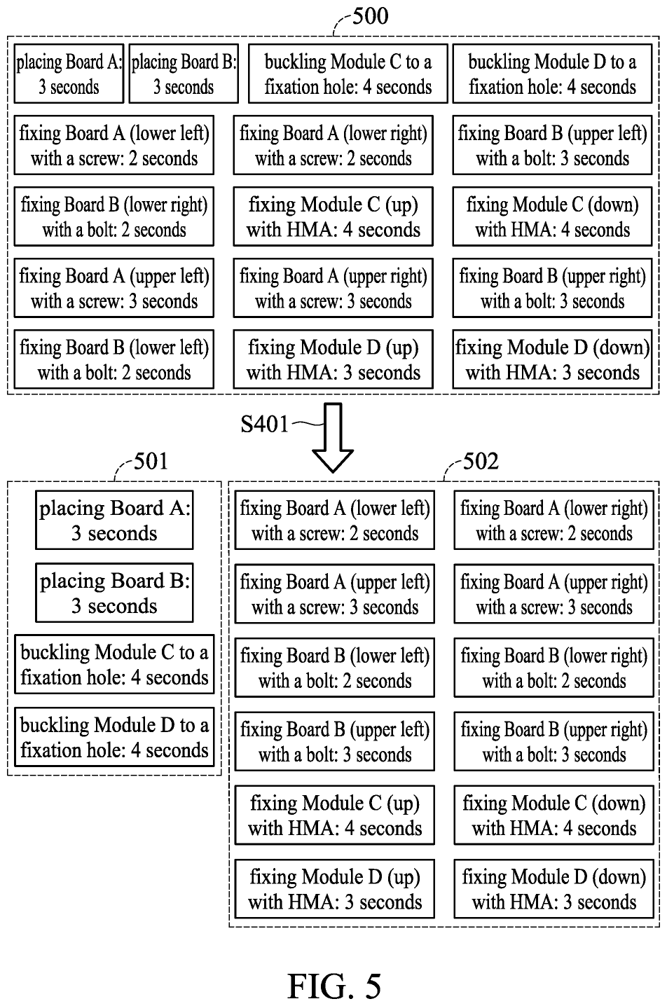

FIG. 5 illustrates the schematic diagram of practicing an example of step S401 in FIG. 4. In this example, multiple assembly operations (such as “placing Board A”, “placing Board B”, “buckling Module C to a fixation hole”, “buckling Module D to a fixation hole”) forms the assembly operation set 500. As shown in FIG. 5, each assembly operation in the assembly operation set 500 has a corresponding operating time. For example, the operating time corresponding to the assembly operation “placing Board A” is 3 seconds, the operating time corresponding to the assembly operation “buckling Module C to a fixation hole” is 4 seconds, and the operating time corresponding to the assembly operation “fixing Board A (lower left) with a screw” is 2 seconds.

In this example, it is assumed that according to the operation priority rule, the assembly operations like “placing Board A”, “placing Board B”, “buckling Module C to a fixation hole”, “buckling Module D to a fixation hole” must be performed before other assembly operations (i.e., “fixing Board A (lower left) with a screw”, “fixing Board B (lower left) with a bolt”, “fixing Module C (up) with HMA” . . . etc.). Therefore, at Step 401, all of the assembly operations in the assembly operation set 500 will be assigned to Group 501 and Group 502. Group 501 has the assembly operations that must be performed first, such as “placing Board A”, “placing Board B”, “buckling Module C to a fixation hole”, “buckling Module D to a fixation hole”, while Group 502 has the other assembly operations in the assembly operation set 500 (i.e., “fixing Board A (lower left) with a screw”, “fixing Board B (lower left) with a bolt”, “fixing Module C (up) with HMA” . . . etc.).

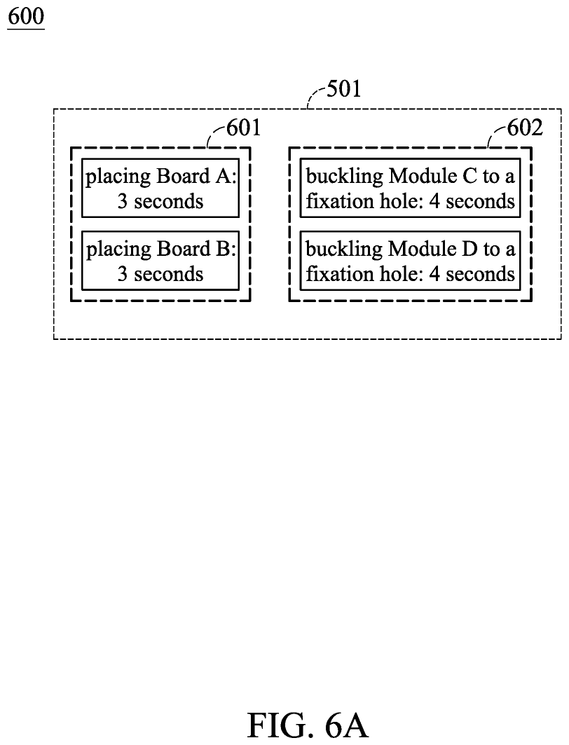

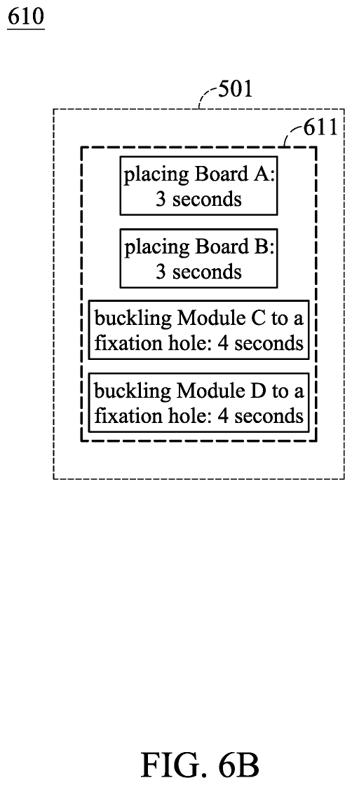

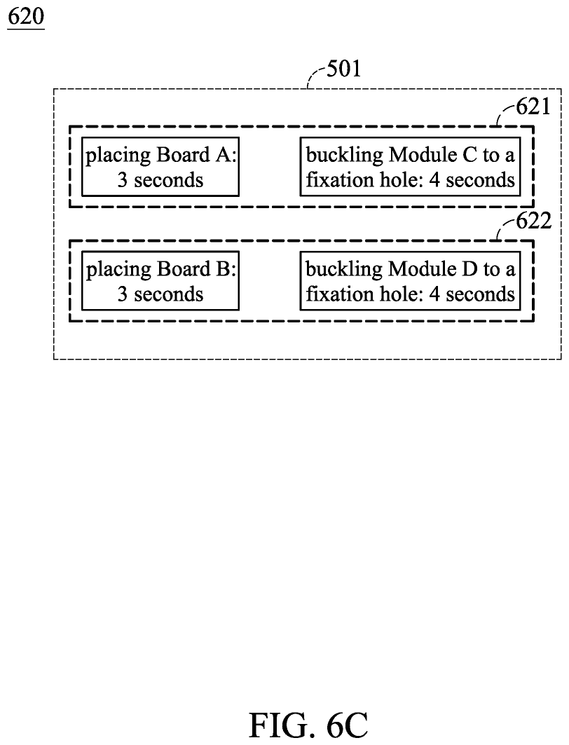

FIG. 6A-6C respectively shows the exemplary local layout 600, 610, and 620 that are added into the local solution of the Group 501 after executing steps S402-S406 in FIG. 4 for the Group 501 in FIG. 5. In this example, it is assumed that there are two operation merging rules, one of which is “merge the same type of actions”, and the other one is “merge placing a board and fixing buckles to a fixation hole”. The local layout that satisfies any one of the operation merging rules may be taken into consideration to whether being added into the local solution. Besides, it is assumed that the upper bound of the station number is 5, the minimum duration of the operating time is 6 seconds, and the maximum duration of the operating time is 16 seconds.

First, the first operation merging rule “merge the same type of actions” is considered. In step S402, according to the first operation merging rule “merge the same type of actions”, all of the assembly operations in Group 501 will be assigned to Subgroup 601 and Subgroup 602. At this moment, the local layout of the subgroups of Group 501 is the local layout 600 shown in FIG. 6A. This means that in the local layout 600, all of the assembly operations in Group 501 will be assigned to two stations, which are responsible for the assembly operations in Subgroup 601 and in Subgroup 602 respectively. As shown in FIG. 6A, the assembly operations “placing Board A” and “placing Board B” in Subgroup 601 have the same type of actions (i.e., placing a board), and the assembly operations “buckling Module C to a fixation hole” and “buckling Module D to a fixation hole” in Subgroup 602 have the same type of actions (i.e., buckling a module to a fixation hole).

The number of subgroups in the local layout 600 is 2, which is lower than the upper bound of the station number (5 stations). Besides, the sum of operating time corresponding to the assembly operations in Subgroup 601 and in Subgroup 602 are 6 seconds (3 seconds for “placing Board A” plus 3 second for “placing Board B”) and 8 seconds (4 seconds for “buckling Module C to a fixation hole” plus 4 seconds for “buckling Module D to a fixation hole”) respectively, both of which are not higher than the maximum duration of the operating time (16 seconds) and not lower than the minimum duration of the operating time (6 seconds). Therefore, the local layout 600 will be added into the local solution of Group 501 in step S403-S404.

Subgroup 601 and Subgroup 602 are both not further divisible. For example, if the assembly operations “placing Board A” and “placing Board B” in Subgroup 601 are further assigned to two subgroups, then the operating time of the two subgroups are both 3 seconds, which is lower than the minimum duration of the operating time and not obeying the conditions of being divisible. Therefore, according to the first operation merging rule “merging the same type of actions”, no more local layouts other than the local layout 600 will be added into the local solution.

Next, the second operation merging rule “merge placing a board and fixing buckles to a fixation hole” is considered. In step S402, according to the second operation merging rule “merge placing a board and fixing buckles to a fixation hole”, all of the assembly operations in Group 501 will be assigned to Subgroup 611. At this moment, the local layout of the subgroups of Group 501 is the local layout 610 shown in FIG. 6B. This means in the local layout 601, all of the assembly operations in Group 501 will be assigned to only one station, which is responsible for the assembly operations in Subgroup 611. As shown in FIG. 6B, Subgroup 611 have all of the assembly operations of Group 501.

The number of subgroups in the local layout 610 is 1, which is lower than the upper bound of the station number (5 stations). Besides, the sum of operating time corresponding to the assembly operations in Subgroup 611 is 14 seconds (3+3+4+4), which is not higher than the maximum duration of the operating time (16 seconds) and not lower than the minimum duration of the operating time (6 seconds). Therefore, the local layout 610 will be added into the local solution of Group 501 in step S403-S404.

In step S405-S406, the assembly operations in Subgroup 611 will be further divided into Subgroup 621 and Subgroup 622. At this moment, the local layout of subgroups of Group 501 is the local layout 620 shown in FIG. 6C. This means that in the local layout 620, all of the assembly operations in Group 501 will be assigned to two stations, which are responsible for the assembly operations in Subgroup 621 and in Subgroup 622 respectively. As shown in FIG. 6C, Subgroup 621 has the assembly operations “placing Board A” and “buckling Module C to a fixation hole”, and Subgroup 622 has the assembly operations “placing Board B” and “buckling Module D to a fixation hole”. The number of subgroups in the local layout 620 is 2, which is lower than the upper bound of the station number (5 stations). Besides, the sum of operating time corresponding to the assembly operations in Subgroup 621 and in Subgroup 622 are both 7 seconds (3+4), which is not higher than the maximum duration of the operating time (16 seconds) and not lower than the minimum duration of the operating time (6 seconds). Therefore, in step S405-S406, Subgroup 611 will be determined to be divisible into Subgroup 621 and Subgroup 622, and the local layout 620 after the division will be added into the local solution of Group 501.

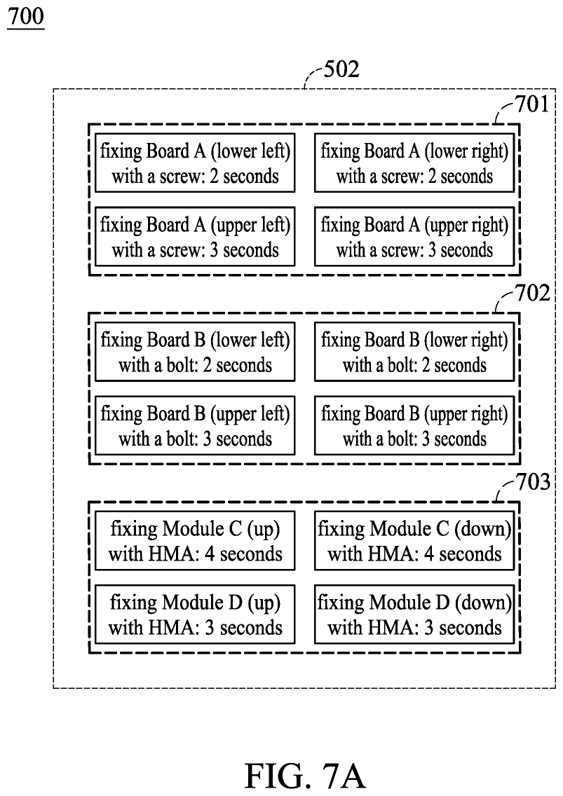

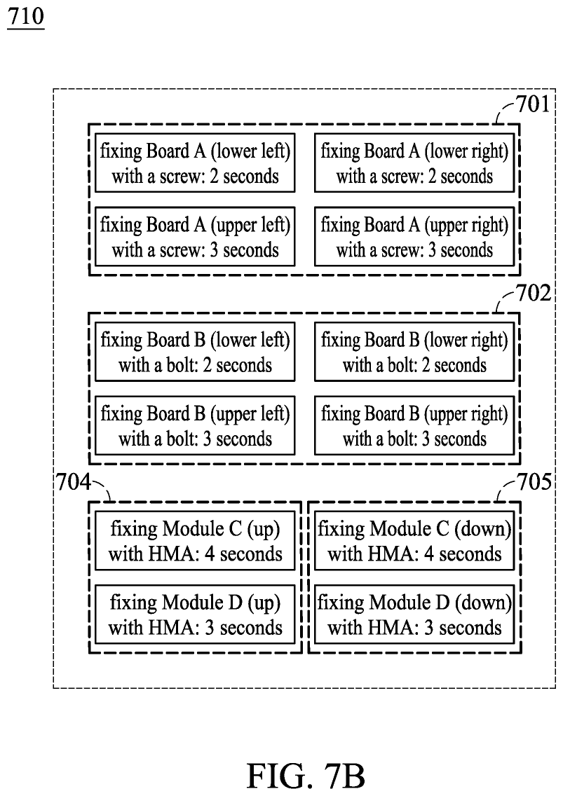

FIG. 7A and FIG. 7B respectively shows the exemplary local layouts 700 and 710 that are added into the local solution of Group 502 after executing steps S402-S406 in FIG. 4 for Group 502 in FIG. 5. In this example, Group 502 does not include the actions of placing a board or buckling a module to a fixation hole, so only the first operation merging rule “merge the same type of actions” is to be considered. Besides, it is still assumed that the upper bound of the station number is 5, the minimum duration of the operating time is 6 seconds, and the maximum duration of the operating time is 16 seconds.

According to the first operation merging rule “merge the same type of actions”, all of the assembly operations in Group 502 will be assigned to Subgroups 701-703 in step S402. At this moment, the local layout of the subgroups of Group 502 is the local layout 700 shown in FIG. 7A. This means that in the local layout 700, all of the assembly operations in Group 502 will be assigned to three stations, which are responsible for the assembly operations in Subgroup 701-703 respectively. As shown in FIG. 7A, Subgroup 701 has assembly operations “fixing Board A (lower left) with a screw”, “fixing Board A (lower right) with a screw”, “fixing Board A (upper left) with a screw”, and “fixing Board A (upper right) with a screw”. Subgroup 702 has assembly operations “fixing Board B (lower left) with a bolt”, “fixing Board B (lower right) with a bolt”, “fixing Board B (upper left) with a bolt”, and “fixing Board B (upper right) with a bolt”. Subgroup 703 has assembly operations “fixing Module C (up) with HMA”, “fixing Module C (down) with HMA”, “fixing Module D (up) with HMA”, and “fixing Module D (down) with HMA”.

The number of subgroups in the local layout 700 is 3, which is lower than the upper bound of the station number (5 stations). Besides, the sum of operating time corresponding to the assembly operations in Subgroup 701-703 are 10 seconds (2+2+3+3), 10 seconds (2+2+3+3), and 14 seconds (4+4+3+3), all of which are not higher than the maximum duration of the operating time (16 seconds) and not lower than the minimum duration of the operating time (6 seconds). Therefore, the local layout 700 will be added into the local solution of Group 502 in step S403-S404.

At step 405, Subgroup 701-703 will be determined whether being divisible into more subgroups. Every possible divided combinations of Subgroup 701 and Subgroup 702 will cause the sum of operating time corresponding to the operation types to be lower than the minimum duration of the operating time (6 seconds), which is not obeying the condition of being divisible. Thus, Subgroup 701 and Subgroup 702 will be determined to be not divisible. Subgroup 703, however, will be determined to be divisible. Besides, at Step 406, the assembly operations in Subgroup 703 will further divided into Subgroup 704 and Subgroup 705. At this moment, the local layout of subgroups of Group 502 is the local layout 710 shown in FIG. 7B. This means that in the local layout 710, all of the assembly operations in Group 502 will be assigned to four stations, which are responsible for the assembly operations in Subgroup 701, Subgroup 702, Subgroup 704, and Subgroup 705 respectively. As shown in FIG. 7B, Subgroup 704 has assembly operations “fixing Module C (up) with HMA” and “fixing Module D (up) with HMA”, and Subgroup 705 has assembly operations “fixing Module C (down) with HMA” and “fixing Module D (down) with HMA”. The number of subgroups in the local layout 710 is 4, which is lower than the upper bound of the station number (5 stations). Besides, the sum of operating time corresponding to the assembly operations in Subgroup 701, Subgroup 702, Subgroup 704, and Subgroup 705 are 10 seconds (2+2+3+3), 10 seconds (2+2+3+3), 7 seconds (4+3), and 7 seconds (4+3) respectively, all of which are not higher than the maximum duration of the operating time (16 seconds) and not lower than the minimum duration of the operating time (6 seconds). Therefore, at steps S405-S406, Subgroup 703 will be determined to be divisible into Subgroup 704 and Subgroup 705, and the local layout 710 after the division will be added into the local solution of Group 502.

Up until now, it is obtained that the local solution of Group 501 includes the local layout 600, the local layout 610, and the local layout 620, and the local solution of Group 502 includes the local layout 700 and the local layout 710. In step S408, the local solution of Group 501 and the local solution of Group 502 will be combined, in other words one of the local layout 600, the local layout 610, and the local layout 620 will be paired with one of the local layout 700 and the local layout 710, so as to generate six assembly line layouts.

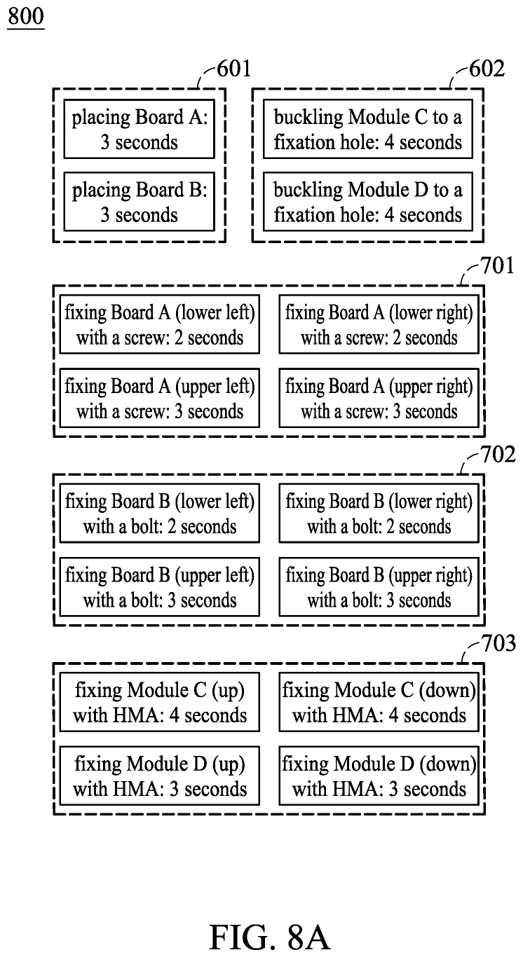

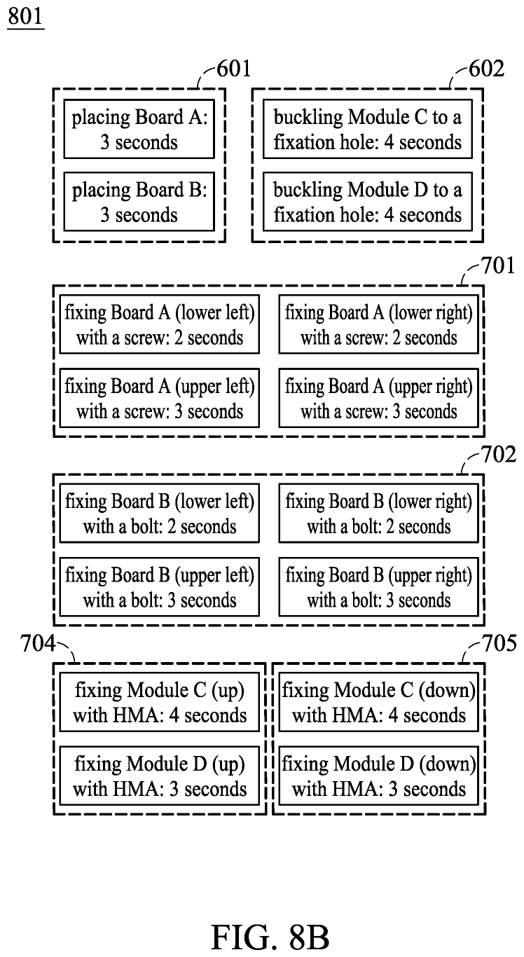

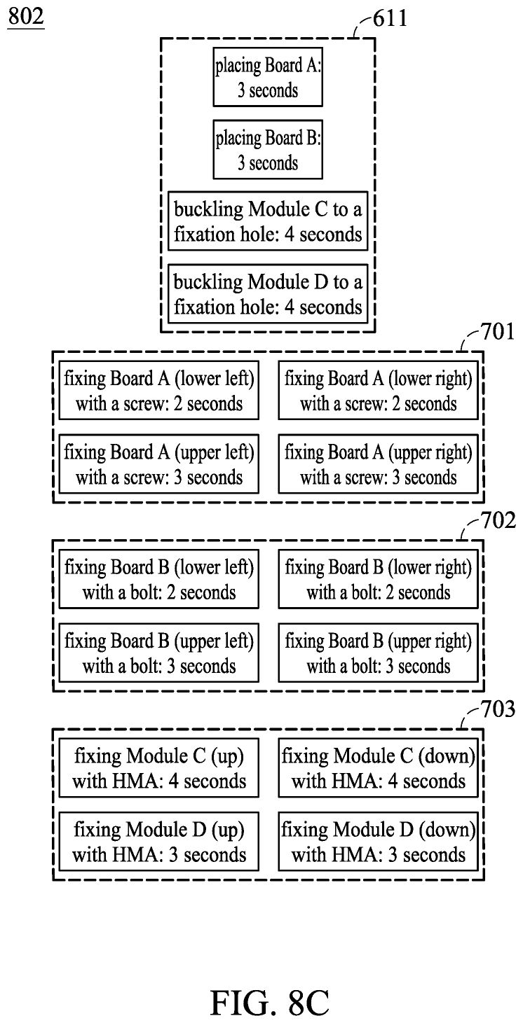

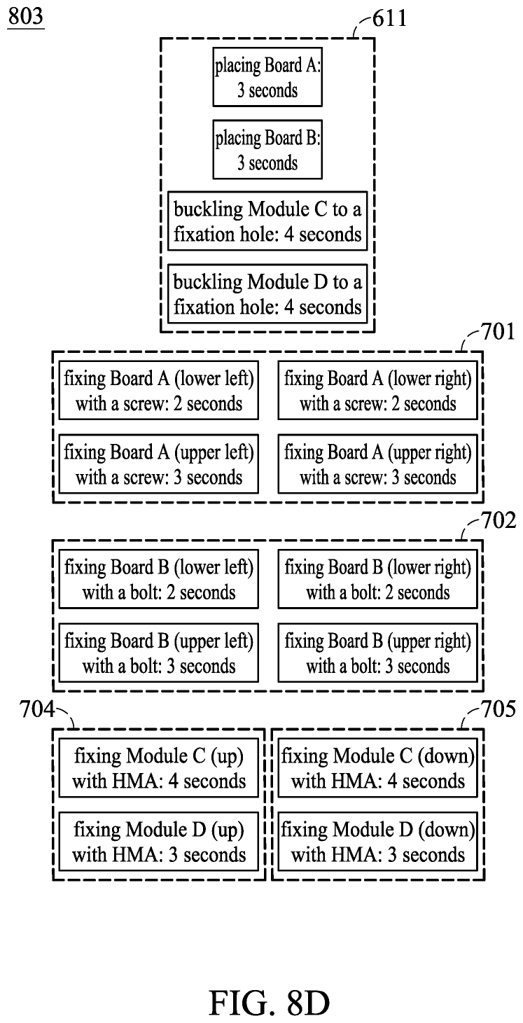

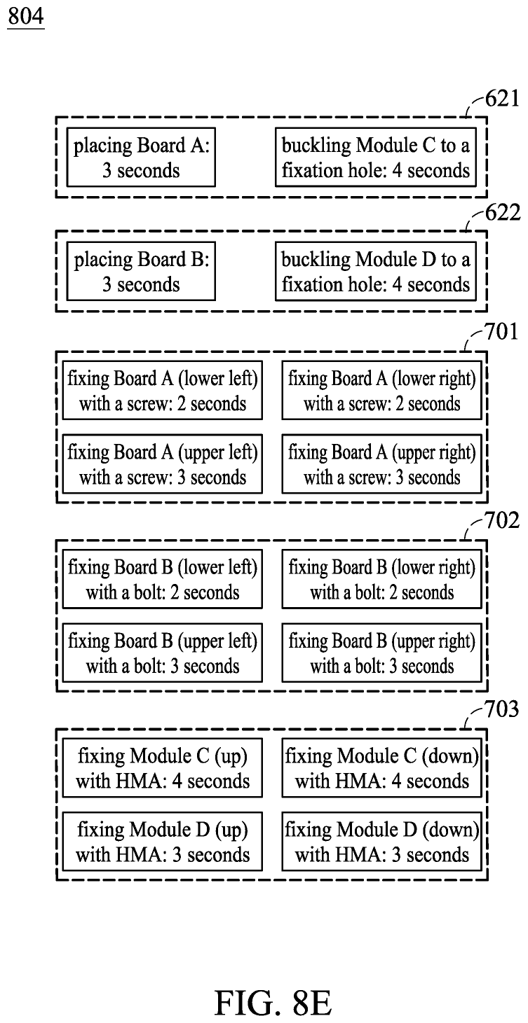

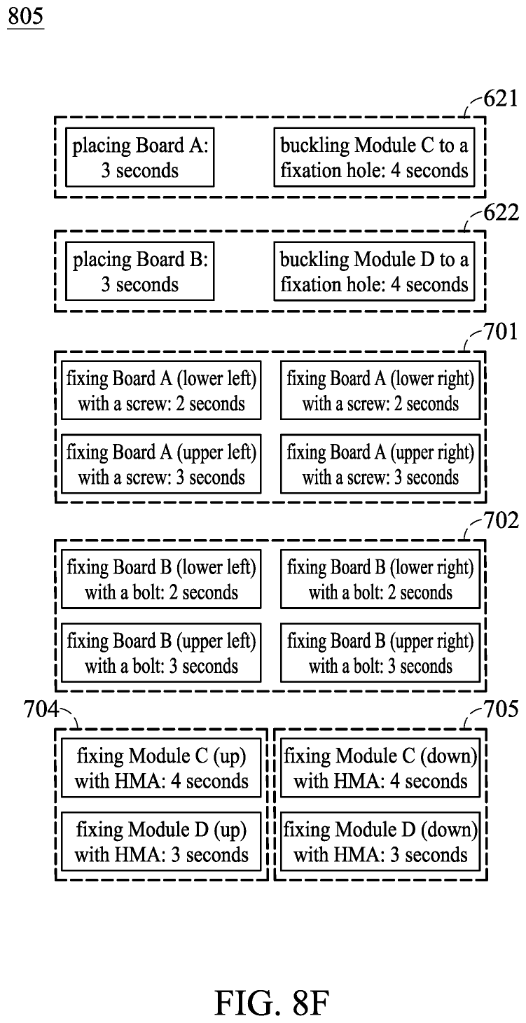

FIG. 8A-8F shows the six assembly line layouts 800-805 generated by executing the steps in FIG. 4 to all of the assembly operations in the assemble operation set 500 in FIG. 5. The ones in these assembly line layouts that satisfy the condition in which the number of stations deployed is not higher than the upper bound of the station number will be regarded as candidate solutions.

In FIG. 8A, the assembly line layout 800 is generated by pairing the local layout 600 of Group 501 and the local layout 700 of Group 502. Therefore, the assembly line layout 800 has Subgroup 601, Subgroup 602, and Subgroup 701-703. All of the assembly operations in the assembly operation set 500 will be assigned to five stations, which are responsible for the assembly operations of Subgroup 601, Subgroup 602, and Subgroup 701-703 respectively. The candidate solution corresponding to the assembly line layout 800 is referred to as “the first candidate solution” hereinafter.

In FIG. 8B, the assembly line layout 801 is generated by pairing the local layout 600 of Group 501 and the local layout 710 of Group 502. Therefore, the assembly line layout 801 has Subgroup 601, Subgroup 602, Subgroup 701-702, and Subgroup 704-705, meaning that all of the assembly operations in the assembly operation set 500 will be assigned to six stations, which are responsible for the assembly operations of Subgroup 601, Subgroup 602, Subgroup 701-702, and Subgroup 704-705 respectively. Due to the number of stations (6) deployed on the assembly line in the assembly line layout 801 is already higher than the upper bound of the station number (5), the assembly line layout 801 is not included in the candidate solutions.

In FIG. 8C, the assembly line layout 802 is generated by pairing the local layout 610 of Group 501 and the local layout 700 of Group 502. Therefore, the assembly line layout 802 has Subgroup 611 and Subgroup 701-703, meaning that all of the assembly operations in the assembly operation set 500 will be assigned to four stations, which are responsible for the assembly operations of Subgroup 611 and Subgroup 701-703 respectively. The candidate solution corresponding to the assembly line layout 802 is referred to as “the second candidate solution” hereinafter.

In FIG. 8D, the assembly line layout 803 is generated by pairing the local layout 610 of Group 501 and the local layout 710 of Group 502. Therefore, the assembly line layout 803 has Subgroup 611, Subgroup 701-702, and Subgroup 704-705, meaning that all of the assembly operations in the assembly operation set 500 will be assigned to five stations, which are responsible for the assembly operations of Subgroup 611, Subgroup 701-702, and Subgroup 704-705 respectively. The candidate solution corresponding to the assembly line layout 803 is referred to as “the third candidate solution” hereinafter.

In FIG. 8E, the assembly line layout 804 is generated by pairing the local layout 620 of Group 501 and the local layout 700 of Group 502. Therefore, the assembly line layout 804 has Subgroup 611-612 and Subgroup 701-703, meaning that all of the assembly operations in the assembly operation set 500 will be assigned to five stations, which are responsible for the assembly operations of Subgroup 611-612 and Subgroup 701-703 respectively. The candidate solution corresponding to the assembly line layout 804 is referred to as “the fourth candidate solution” hereinafter.

In FIG. 8F, the assembly line layout 805 is generated by pairing the local layout 620 of Group 501 and the local layout 710 of Group 502. Therefore, the assembly line layout 805 has Subgroup 621-622, Subgroup 701-702, and Subgroup 704-705, meaning that all of the assembly operations in the assembly operation set 500 will be assigned to six stations, which are responsible for the assembly operations of Subgroup 621-622, Subgroup 701-702, and Subgroup 704-705 respectively. Due to the number of stations (6) deployed on the assembly line in the assembly line layout 805 is already higher than the upper bound of the station number (5), the assembly line layout 805 is not included in the candidate solutions.

In some embodiments, the workload balance information described in step S203 in FIG. 2 includes a maximum action types for single station and a maximum amount of operating time for single station. The maximum action types for single station refers to the number of action types of the subgroup that has the most action types of all of the subgroups of the candidate solution. The maximum amount of operating time for single station refers to the sum of operating time corresponding to the assembly operations of the subgroup that has the highest sum of operating time corresponding to all of the assembly operations of all of the subgroups of the candidate solution.

For example, in the assembly line layout 804 corresponding to the fourth candidate solution, Subgroup 621 and Subgroup 622 have two types of actions (placing a board and buckling a module to a fixation hole), Subgroup 701 has only one type of actions (fixing a board with a screw), Subgroup 702 has only one type of actions (fixing a board with a bolt), and Subgroup 703 has only one type of actions (fixing a module with HMA). Thus it can be seen that in the assembly line layout 804, the subgroups having the most action types are Subgroup 621 and Subgroup 622, the number of action types of which is 2. Therefore, the maximum action types for single station of the fourth candidate solution is 2.

For example, in the assembly line layout 804 corresponding to the fourth candidate solution, the sums of operating time corresponding to all of the assembly operations of Subgroup 621 and of Subgroup 622 are both 7 seconds (3+4), the sums of operating time corresponding to all of the assembly operations of Subgroup 701 and of Subgroup 702 are both 10 seconds (2+2+3+3), and the sum of operating time corresponding to all of the assembly operations of Subgroup 703 is 14 seconds (4+4+3+3). Thus it can be seen that in the assembly line layout 804, the subgroup that has the highest sum of operating time corresponding to all of the assembly operations is Subgroup 703, the sum of operating time corresponding to all of the assembly operations of which is 14 seconds. Therefore, the maximum amount of operating time for single station of the fourth candidate solution is 14 seconds.

The maximum action types for single station and the maximum amount of operating time for single station of the first candidate solution, the second candidate solution, the third candidate solution, and the fourth candidate solution are listed in <Table I> as follows.

TABLE I

| | maximum action | maximum amount |
|---|---|---|
| Candidate | types for single | of operating time |
| Solutions | station | for single station |
| The first | 1 | 14 |
| candidate solution | | |
| The second | 2 | 14 |
| candidate solution | | |
| The third | 2 | 14 |
| candidate solution | | |
| The fourth | 2 | 14 |
| candidate solution | | |

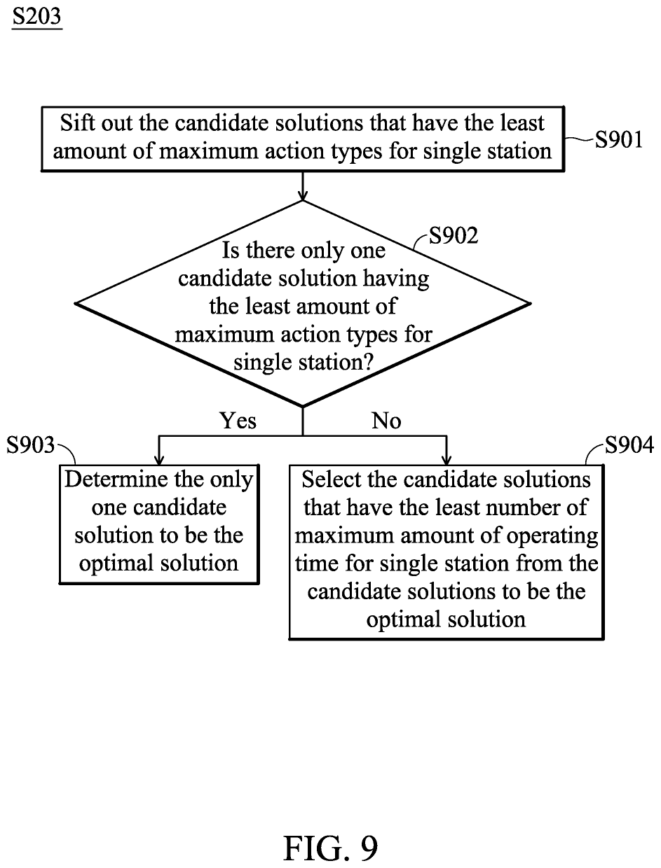

FIG. 9 illustrates the flow diagram of the detailed steps of Step 203 in FIG. 2 in an embodiment. In this embodiment, as shown in FIG. 9, Step 203 may be further divided into steps S901-S904.

In step S901, the candidate solutions that have the least amount of maximum action types for single station are sifted out. Then, proceed to step S902.

In step S902, whether there is only one candidate solution having the least amount of maximum action types for single station is determined. If yes, proceed to step S903. If no, proceed to step S904.

In step S903, the only one candidate solution is determined to be the optimal solution.

In step S904, the candidate solutions that have the least number of maximum amount of operating time for single station are selected from all of the candidate solutions to be the optimal solution.

For example, among the four candidate solutions listed in <Table I>, the first candidate solution is the candidate solution with the least amount of maximum action types for single station (1). Therefore, in this embodiment, the selected optimal solution is the first candidate solution.

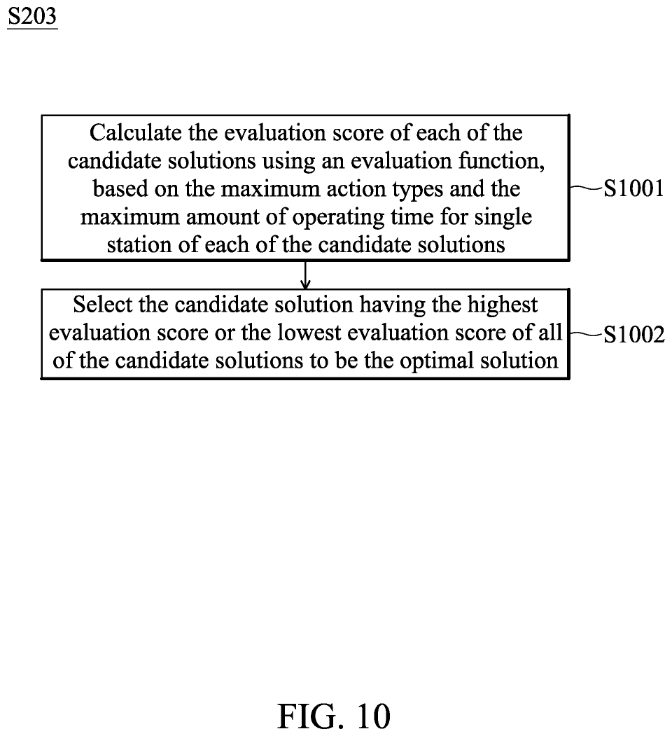

FIG. 10 illustrates the flow diagram of the detailed steps of step S203 in FIG. 2 in another embodiment. In this embodiment, as shown in FIG. 10, step S203 may be further divided into steps S1001-S1002.

In step S1001, the evaluation score of each of the candidate solutions is calculated using an evaluation function, based on the maximum action types for single station and the maximum amount of operating time for single station of each of the candidate solutions. Then, proceed to step S1002.

In step S1002, the candidate solution having the highest evaluation score or the lowest evaluation score of all of the candidate solutions is selected to be the optimal solution.

In an embodiment, the formula of the first evaluation function used in step S1001 is as follows:

$$Evaluation score of the target candidate solution = \frac{1}{\begin{matrix}maximum action types for single station \\ of the target candidate solution\end{matrix}} + \frac{\begin{matrix}maximum amount of operating time for single station \\ \begin{matrix}of all candidate solutions - \\ \begin{matrix}maximum amount of operating time for single station \\ of the target candidate solution\end{matrix}\end{matrix}\end{matrix}}{\begin{matrix}maximum amount of operating time for single station \\ \begin{matrix}of all candidate solutions - \\ \begin{matrix}minimum operating time for single station \\ of all candidate solutions + 1\end{matrix}\end{matrix}\end{matrix}}$$

In this embodiment, the optimal solution is the candidate solution that has the highest evaluation score among multiple candidate solutions.

For example, among the four candidate solutions listed in Table I, the maximum amount of operating time for single station of all candidate solutions is the sum of the operating time corresponding to all of the assembly operations in Subgroup 611 or Subgroup 703 (14 seconds). The minimum operating time for single station of all candidate solutions is the sum of the operating time corresponding to all of the assembly operations in Subgroup 601 (6 seconds). Therefore, in this embodiment, the first evaluation score of each candidate solutions are calculated as follows:

$$The first evaluation score of the first candidate solution = \frac{1}{1} + \frac{14 - 14}{14 - 6 + 1} = 1$$

$$The first evaluation score of the second candidate solution = \frac{1}{2} + \frac{14 - 14}{14 - 6 + 1} = \frac{1}{2}$$

$$The first evaluation score of the third candidate solution = \frac{1}{2} + \frac{14 - 14}{14 - 6 + 1} = \frac{1}{2}$$

$$The first evaluation score of the fourth candidate solution = \frac{1}{2} + \frac{14 - 14}{14 - 6 + 1} = \frac{1}{2}$$

As it can be seen, among the four candidate solutions listed in <Table I>, the first candidate solution has the highest first evaluation score (1). Therefore, in this embodiment, the optimal solution selected is the first candidate solution.

In another embodiment, the second evaluation function used in step S1001 is the reciprocal of the first evaluation function. In such cases, the optimal solution is the candidate having the lowest evaluation score among multiple candidates.

In some embodiments, after the optimal solution is calculated, the conveyer belt speed corresponding to the optimal solution may be calculated based on the maximum amount of operating time for single station of the optimal solution, and external parameters such as the width of the object working area and the width of hand motions. The formula is as follows:

$$Conveyer belt speed = \frac{width of object working area + width of hand motions}{\begin{matrix}maximum amount of operating time for single station \\ of the optimal solution\end{matrix}}$$

In some embodiments, after the optimal solution and the corresponding conveyer belt speed are calculated, the estimated production capacity corresponding to the optimal solution may be calculated based on the maximum amount of operating time for single station of the optimal solution, the conveyer belt speed, and external parameters such as the length of the assembly line and the working duration. The formula is as follows:

$$Estimated production capacity = \frac{working duration + \frac{length of the assembly line}{conveyer belt speed}}{\begin{matrix}maximum amount of operating time for single station \\ of the optimal solution\end{matrix}} + 1$$

The method and system for optimizing a manual assembly layout is capable of immediately providing suggestions for optimizing the assembly line layout according to the on-site status of the assembly line, so that the assembly actions at each station is simplified, the workload among each stations is balanced, and the yield and the production capacity could be increased.

Ordinal terms used in the claims, such as “first,” “second,” “third,” etc., are only for the convenience of explanation, and have no sequential relationship with each other.

The above paragraphs are described with multiple aspects. Obviously, the teachings of the specification may be performed in multiple ways. Any specific structure or function disclosed in examples is only a representative situation. According to the teachings of the specification, it should be noted by those skilled in the art that any aspect disclosed may be performed individually, or that more than two aspects could be combined and performed.

While the present disclosure has been described above by way of embodiments, the present disclosure is not limited thereto. The present disclosure may be modified and adjusted by any persons skilled in the art without departing from the spirit and scope of the present disclosure. The scope of protection is subject to the scope of the claims.

What is claimed is:

1. A method for optimizing a manual assembly line layout, executed by a processing device, comprising:
analyzing an assembly operation of one or more assemblers and an operating time corresponding to the assembly operation based on the operating information of the one or more assemblers;
generating a plurality of candidate solutions based on the assembly operation, the operating time, and a plurality of condition parameters, wherein each of the candidate solutions indicates an assembly line layout that assigns the assembly operations to a plurality of stations;
selecting at least one of the candidate solutions to be an optimal solution based on a workload balance information of each of the candidate solutions.

2. The method as claimed in claim 1, wherein the condition parameters comprise an upper bound of the station number; and
wherein number of stations is not higher than the upper bound of the station number.

3. The method as claimed in claim 2, wherein the condition parameters further comprise an minimum duration of the operating time, a maximum duration of the operating time, an operation priority rule, and an operation merging rule; and
wherein the assembly line layouts that assign the assembly operations to the stations and are indicated by the candidate solutions all follow the operation priority rule and the operation merging rule; and
wherein the sum of the operating time corresponding to the assembly operations that are assigned to each of the stations is not lower than the minimum duration of the operating time and not higher than the maximum duration of the operating time.

4. The method as claimed in claim 3, wherein generating the candidate solutions based on the assembly operations, the operating time, and the condition parameters comprises:
assigning the assembly operations to a plurality of groups according to the operation priority rule;
for each of the groups, assigning the assembly operations in the group to one or more subgroups according to the operation merging rule;
determining whether to add a local layout of the one or more subgroups into a local solution of the group according to the minimum duration of the operating time, the maximum duration of the operating time, and the upper bound of the station number;
generating the candidate solutions by combining the local solutions of the groups.

5. The method as claimed in claim 4, wherein generating the candidate solutions based on the assembly operations, the operating time, and the condition parameters further comprises:
for each of the subgroups, determining whether the subgroup is divisible according to the minimum duration of the operating time, the maximum duration of the operating time, and the upper bound of the station number;
dividing the subgroup if the subgroup is divisible, and adding the local layout of the subgroups that have been divided into the local solution of the group.

6. The method as claimed in claim 4, wherein determining whether to add the local layout of the one or more subgroups into the local solution of the group according to the minimum duration of the operating time, the maximum duration of the operating time, and the upper bound of the station number comprises:
determining to add the local layout of the one or more subgroups into the local solution of the group if the number of subgroups is not higher than the upper bound of the station number, and the sum of the operating time corresponding to the assembly operations in the one or more subgroups are all not lower than the minimum duration of the operating time and not higher than the maximum duration of the operating time.

7. The method as claimed in claim 3, further comprising:
calculating the minimum duration of the operating time and the maximum duration of the operating time based on a width of an object working area, a width of hand motions, and a range of conveyer belt speeds.

8. The method as claimed in claim 2, further comprising:
calculating the upper bound of the station number based on station capacity and number of dispatchable workers.

9. The method as claimed in claim 2, wherein the workload balance information comprises a maximum action types for single station and a maximum amount of operating time for single station.

10. The method as claimed in claim 9, wherein selecting at least one of the candidate solutions to be the optimal solution based on the workload balance information of each of the candidate solutions comprises:
sifting one or more candidate solutions having the least amount of maximum action types for single station of all of the candidate solutions;
if only one candidate solution has the least amount of maximum action types for single station of all of the candidate solutions, determining that candidate solution to be the optimal solution;
if multiple candidate solutions have the least amount of maximum action types for single station of all of the candidate solutions, selecting the candidate solution having the least number of maximum amount of operating time for single station of all the multiple candidate solutions to be the optimal solution.

11. The method as claimed in claim 9, wherein selecting at least one of the candidate solutions to be the optimal solution based on the workload balance information of each of the candidate solutions comprises:
calculating an evaluation score for each of the candidate solutions using an evaluation function, based on the maximum action types for single station and the maximum amount of operating time for single station of each of the candidate solutions;
selecting the candidate solution having the highest evaluation score or the lowest evaluation score of all of the candidate solutions to be the optimal solution.

12. The method as claimed in claim 9, further comprising:
calculating a conveyer belt speed corresponding to the optimal solution based on the maximum amount of operating time for single station of the optimal solution, the width of the object working area, and a width of hand motions.

13. The method as claimed in claim 12, further comprising:
calculating an estimated production capacity corresponding to the optimal solution based on the maximum amount of operating time for single station of the optimal solution, a length of the assembly line, a working duration, and the conveyer belt speed.

14. The method as claimed in claim 1, wherein analyzing the assembly operation of each of the assemblers, and the operating time corresponding to the assembly operation, based on the operating information of the one or more assemblers comprises:
analyzing an action, an object in-hand, and an operated object from the operating information of each of the assemblers;
obtaining the assembly operation of the assembler based on the action, the object in-hand, and the operated object.

15. A system for optimizing a manual assembly line layout, comprising:
an information-collecting unit, configured to collect operating information of one or more assemblers;
a computing unit, connected to the information-collecting unit, including a processing device that is configured to receive the operating information of the assemblers collected by the information-collecting unit, and execute operations as follows:
analyzing an assembly operation of each of the assemblers and the operating time corresponding to the assembly operation based on the operating information of the assemblers;
generating a plurality of candidate solutions based on the assembly operations, the operating time, and a plurality of condition parameters, wherein each of the candidate solutions indicates an assembly line layout that assigns the assembly operations to a plurality of stations;
selecting at least one of the candidate solutions to be an optimal solution based on a workload balance information of each of the candidate solutions.

16. The system as claimed in claim 15, wherein the condition parameters further comprise a upper bound of the station number, an minimum duration of the operating time, a maximum duration of the operating time, an operation priority rule, and an operation merging rule; and
wherein number of stations is not higher than the upper bound of the station number;
wherein the assembly line layouts that assign assembly operations to the stations and are indicated by the candidate solutions all follow the operation priority rule and the operation merging rule; and
wherein sum of the operating time corresponding to the assembly operations that are assigned to each of the stations is not lower than the minimum duration of the operating time and not higher than the maximum duration of the operating time.

17. The system as claimed in claim 16, wherein generating the candidate solutions based on the assembly operations, the operating time, and the condition parameters comprises:
assigning the assembly operations to a plurality of groups according to the operation priority rule;
for each of the groups, assigning the assembly operations in the group to one or more subgroups according to the operation merging rule;
determining whether to add the local layout of the one or more subgroups into a local solution of the group according to the minimum duration of the operating time, the maximum duration of the operating time, and the upper bound of the station number;
for each of the subgroups, determining whether the subgroup is divisible according to the minimum duration of the operating time, the maximum duration of the operating time, and the upper bound of the station number;
dividing the subgroup if the subgroup is divisible, and adding the local layout of the subgroups that have been divided into the local solution of the group;
generating the candidate solutions by combining the local solutions of the groups.

18. The system as claimed in claim 17, wherein determining whether to add the local layout of the one or more subgroups into the local solution of the group according to the minimum duration of the operating time, the maximum duration of the operating time, and the upper bound of the station number comprises:
determining to add the local layout of the one or more subgroups into the local solution of the group if the number of subgroups is not higher than the upper bound of the station number, and the sum of the operating time corresponding to the assembly operations in the subgroups is not lower than the minimum duration of the operating time and not higher than the maximum duration of the operating time.

19. The system as claimed in claim 16, wherein the workload balance information comprises a maximum action types for single station and a maximum amount of operating time for single station; and
wherein selecting at least one of the candidate solutions to be the optimal solution based on the workload balance information of each of the candidate solutions comprises:
sifting one or more candidate solutions having the least amount of maximum action types for single station of all of the candidate solutions;
if only one candidate solution has the least amount of maximum action types for single station of all of the candidate solutions, determining one candidate solution to be the optimal solution;
if multiple candidate solutions have the least amount of maximum action types for single station of all of the candidate solutions, selecting the candidate solution having the least number of maximum amount of operating time for single station of all the multiple candidate solutions to be the optimal solution.

20. The system as claimed in claim 16, wherein the workload balance information comprises a maximum action types for single station and a maximum amount of operating time for single station; and
wherein selecting at least one of the candidate solutions to be the optimal solution based on the workload balance information of each of the candidate solutions comprises:
calculating an evaluation score of each of the candidate solutions using an evaluation function, based on the maximum action types for single station and the maximum amount of operating time for single station of each of the candidate solutions;
selecting the candidate solution having the highest evaluation score or the lowest evaluation score of all of the candidate solutions to be the optimal solution.

21. The system as claimed in claim 16, wherein the workload balance information comprises a maximum action types for single station and a maximum amount of operating time for single station, and the processing device is further configured to execute operations as follows:
calculating a conveyer belt speed corresponding to the optimal solution based on the maximum amount of operating time for single station of the optimal solution, and the width of the object working area and a width of hand motions;
calculating an estimated production capacity corresponding to the optimal solution based on the maximum amount of operating time for single station of the optimal solution, and a length of the assembly line, a working duration, and the conveyer belt speed.
